(19) United States
(12) Patent Application Publication
(10) Pub. No.: US 2006/0083841 A1
(43) Pub. Date: Apr. 20, 2006

(54) High expansion dough compositions and methods

(76) Inventors: Jeffrey L. Casper, Minneapolis, MN (US); Alan A. Oppenheimer, Savage, MN (US); Jean L. Weber, Plymouth, MN (US); Braden J. Erickson, Eden Prairie, MN (US); Madonna M. Ray, Vadnais Heights, MN (US)

Correspondence Address: GENERAL MILLS, INC., P.O. BOX 1113, MINNEAPOLIS, MN, 55440, US

(21) Appl. No.: 11/249,678

(22) Filed: Oct. 13, 2005

Related U.S. Application Data
(60) Provisional application No. 60/618,613, filed on Oct. 14, 2004.

(51) Int. Cl. A21D 10/00

(52) U.S. Cl. 426/549

(57) ABSTRACT

Described are dough compositions and related methods wherein the dough compositions include a starch having a low, high-temperature viscosity, e.g., to produce an unproofed dough composition that can be baked without proofing.

### PRIORITY CLAIM

The present non-provisional Patent Application claims the benefit of priority under 35 USC 119 from commonly owned United States Provisional Patent Application having Ser. No. 60/618,613, filed on Oct. 14, 2004, in the name of Casper et al., and titled HIGH EXPANSION DOUGH COMPOSITIONS AND METHODS, which Patent Application is incorporated herein by reference in its entirety.

### FIELD OF THE INVENTION

The invention relates to dough compositions and methods, wherein the doughs contain specific types and amounts of protein and starch.

### BACKGROUND

Dough products are prepared by combining ingredients including yeast, water, and flour, among others. The ingredients are combined and processed together to achieve desired properties in a raw or cooked dough, such as desired taste, aroma, texture, color, storage stability, and baking and rheological properties that result in one or more of these. Rheological and mechanical properties of a raw dough such as strength, elasticity, and gas-holding capacity can directly affect baking properties such as the ability of a dough to expand during baking.

Dough ingredients can be combined using any of a multitude of specific steps and techniques to achieve desired raw and baked properties. Useful techniques include two different methods sometimes referred to as “straight-dough” methods and “preferment” methods. According to straight-dough methods, all ingredients of a dough are mixed together to form a dough mass that can be formed to a dough and cooked. According to preferment methods (or, among other terms, “sponge” methods) ingredients can be combined in two (or more) separate steps. In a first step a dough “preferment” composition is prepared to include a portion of total dough ingredients such as flour, water, yeast, and yeast food. This portion of mixed ingredients is then allowed to rest or ferment. In a second step, the balance of the total dough ingredients is added to the fermented dough composition, after a certain amount of processing (e.g., “resting”) of the preferment dough composition. According to standard methods, yeast of this dough composition is again allowed to ferment in a “proofing” step that leavens the finished dough composition before cooking. Upon cooking, the proofed dough will exhibit a recognizable flavor and aroma of a fresh-baked yeast-leavened dough product as well as a light (leavened) composition due to the leavening that took place during the proofing step.

In the dough and bread-making arts there is ongoing need for new and useful dough compositions, e.g., that exhibit utility based on product quality, cost, or convenience. In one specific respect, consumers desire convenience of use. Dough compositions that can be stored for extended periods of time, and used at will, are appreciated by consumers. Also appreciated are dough products that do not require a substantial amount of time or effort to prepare following removal from storage. In this respect, certain types of dough products that may be particularly favored by consumers are those that can be prepared without a time consuming proofing step. For example, such a dough composition may be removed from refrigerated or frozen storage and placed into an oven for baking, without a thawing step, without a proofing step, or without either.

### SUMMARY

The invention relates to dough compositions and dough products that include specific types of starch that exhibits what is referred to as a “low, high-temperature viscosity,” and an elevated protein level. It has been found that dough compositions that include a starch that exhibits this type of viscosity, in combination with an elevated level of protein, exhibit desirable or advantageous rheological properties that can result in desired properties upon cooking, such as desired cooked (e.g., baked) specific volume.

The dough compositions and products include finished and un-finished (e.g., in-process) dough compositions, such as raw doughs and preferment or sponge dough compositions, as well as finished and cooked (e.g., baked, fried, etc.) dough products prepared from the unfinished or in-process dough compositions.

The invention also relates to methods of making these various finished, unfinished, cooked, or in-process dough compositions. The dough compositions can be prepared generally by any useful method, including straight-dough methods and methods that involve a preferment or a sponge dough composition.

Straight-dough methods can be used, whereby all or substantially all of the ingredients of a dough composition are combined together generally at the same time.

Other methods can also be useful, including methods that involve preparing a “preferment” dough composition. According to a “preferment” (or “sponge,” etc.) method, a finished dough composition is prepared to include a preferment dough composition combined with additional dough ingredients. According to certain specific embodiments, a dough composition can be prepared by preparing a preferment dough composition that includes protein in the form of a concentrated protein ingredient, and starch having a relatively low, high-temperature viscosity. The combination of including added protein and starch as described, results in useful and desirable properties of a dough composition, including useful leavening properties, as are described herein.

Thus, the invention contemplates dough compositions prepared by various methods, and that include certain types of starch that exhibit a relatively low, high-temperature viscosity (a relatively low “hot viscosity”). Without being bound by theory, native wheat starch such as starch typically found in many varieties of wheat and flour ingredients used to prepare many dough products, is not ideal for the performance of certain unproofed dough products, such as freezer-to-oven dough products. According to the invention, native wheat starch normally used to prepare standard or conventional dough compositions can be replace with or diluted with starch that provides better properties for a desired dough composition, such as an unproofed dough composition that does not require proofing prior to baking, e.g., that can be baked from a frozen state. As an example, it has been found that starches that exhibit a relatively low viscosity at high temperatures (150-212° F.), e.g., relative to native wheat starch, can improve baking properties of unproofed doughs. Amylopectin, modified corn starch, and modified wheat starch, are examples of such types of starch. Amylopectin can be found in certain types of natural wheats or flours prepared from certain natural wheats, including waxy wheat and waxy wheat flour. Amylopectin can also be found in commercial starch materials.

Starch having a relatively low, high-temperature viscosity may be included in a dough composition by any mode or at any stage of preparing a dough composition, e.g., as part of a wheat ingredient or as part of another ingredient that contains the starch. The starch can be added to other ingredients at any useful or convenient time in preparing a dough, such as with other ingredients in a straight-dough method; with other ingredients to prepare a preferment composition; or to a preferment dough composition after the preferment has been prepared, optionally after the preferment composition has been rested.

The effect of including a starch having the described, relatively low high-temperature viscosity, is to dilute the rheological effects of the standard native wheat starches normally used in certain types of dough compositions. A starch as described herein can exhibit a lower viscosity at high temperature compared to the native wheat starch in a conventional flour. The lower viscosity at high temperature (e.g., temperatures experienced during baking) can affect the amount of expansion a dough composition experiences during baking. A dough composition can expand upon being baked, during the portion of the baking cycle up until the starch increases in viscosity to a point at which the overall effect of the starch inhibits further expansion of the dough. Thus, starches that maintain a lower viscosity during baking (e.g., a as measured in terms of a “hot-viscosity”) can experience expansion during a greater portion of a baking cycle. During baking up until up until the increasing viscosity of the starch begins to inhibit further expansion of the dough composition, the rheology of the overall dough is sufficiently viscoelastic to allow stretching of the dough matrix and expansion of the dough, as gases within the dough expand due to the increased temperature caused by cooking. The use of a starch that has a relatively low viscosity into a baking cycle, e.g., as measured by “hot viscosity,” allows for an extended portion of a baking cycle during which the dough composition has the ability to expand. Overall, a relatively low “hot viscosity” can result in a greater period of a baking cycle during which expansion of the dough composition can occur, resulting in an overall greater amount of expansion of a dough composition during baking, and consequently a higher baked specific volume.

Generally, standard or well-known flour-based dough systems produce a cooked dough product having a cellular structure that results from gas bubble nuclei (or “cells”) formed within a dough matrix while dough ingredients are mixed together. According to certain methods that involve the use of a “preferment” dough composition, a step of preparing a preferment dough composition results in the production of bubbles in the dough, and also produces carbon dioxide that will eventually cause the bubbles to expand and cause the dough to leaven to an expected structure and texture. The bubbles ultimately give rise to the cellular structure observed in the cooked dough product. The distribution of the bubbles and the ability of the bubbles within the matrix to hold gas influence the volume of a baked dough product and whether or not a baked dough product will exhibit the expected light and cellular texture of a baked dough product. Another influence of cooked dough qualities can be the amount of expansion and ultimate size of bubbles produced during baking, which can depend on factors such as the amount of gas contained in a bubble or absorbed in the dough composition; mechanical and rheological properties of a dough matrix such as strength and elasticity, and how those properties may change during baking (e.g., based on rheological changes of starch and protein, as well as changes in water associations during baking; this includes the gelatinization of starch).

An ingredient of typical dough compositions is flour, which contains the protein gluten. Gluten is the wheat grain protein component of dough responsible for many dough properties including mechanical properties of a dough matrix that allow the dough to be processed and to expand during baking. For example, gluten provides the dough matrix with strength to trap and hold gas in the form of bubbles, during preparation of a preferment composition and also when additional ingredients are added to a preferment dough composition to form a finished dough.

According to the invention, a dough composition (finished or unfinished), in addition to any amount of gluten included from flour, includes additional protein, e.g., in the form of a concentrated protein ingredient. A concentrated protein ingredient can be added to the dough at any stage of preparation of a dough composition in an amount to increase the strength of the dough matrix. Concentrated protein ingredient can be combined with other dough ingredients in a straight-dough method, with other ingredients to prepare a preferment composition; or can be added to a preferment dough composition after the preferment has been prepared and optionally after the preferment composition has been rested.

Increased strength of a dough matrix resulting from the concentrated protein ingredient can improve the gas-holding capacity of the dough matrix, thereby allowing for an increase in expansion of the dough during cooking and an increase in the final specific volume of the cooked (e.g., baked) dough product. The additional protein included in the dough composition can be any protein that is capable of improving strength and gas-holding properties of the dough matrix, such as, e.g., gluten, albumen, milk proteins, legume proteins, and combinations of these.

Thus, the present invention involves ingredients of finished or in-process (unfinished) dough compositions that include an elevated amount of protein, e.g., as produced by the use of a concentrated protein ingredient; and starch having a relatively lower high-temperature viscosity compared to native wheat starch. Native wheat starch can be defined as intact wheat starch granules obtained through conventional wet milling processes possessing their native structure and physicochemical properties.

According to certain embodiments of the invention, a dough composition is prepared by a method that uses a preferment or sponge dough composition, wherein the preferment dough composition includes an elevated level of protein during fermentation. The use of a preferment or sponge dough composition can produce carbon dioxide and other gases or water vapor in a cellular dough structure. Inclusion of added protein in a preferment dough composition, during fermentation, e.g., in the form of a concentrated protein ingredient, can result in a dough matrix having mechanical properties that improve the gas-holding capacity of the dough matrix, such as good viscoelastic properties. Inclusion in a dough composition of starch having a relatively low viscosity at high temperature, added either to a preferment composition or later, allows for an extended portion of a cooking cycle during which the dough composition can expand by delaying an increase in viscosity of the dough composition matrix or the starch, after which increase further expansion can be inhibited or prevented. The combined effects of the carbon dioxide produced within the preferment composition, a strengthened matrix produced by an elevated protein level in the preferment dough composition, and reduced viscosity of the starch during baking, allow a greater amount of overall expansion of the dough composition during cooking (e.g., baking), and consequently a higher cooked (e.g., baked) specific volume.

Advantageously, the described combination of starch and protein ingredients, according to specific embodiments of the invention, can result in specific leavening properties of a dough composition. Exemplary baked specific volumes that can be achieved may be in excess of 3.5 cubic centimeters per gram (cc/g), e.g., greater than 4 or 5 cc/g, or more. According to certain embodiments of dough compositions of the invention, a dough composition can be cooked, e.g., baked, from an unproofed state, to a specific volume that is greater than dough compositions made without the described combination of a starch and protein ingredients, optionally prepared by a preferment method.

Certain examples of dough compositions of the invention can be baked from an unproofed state, directly, without proofing, to produce a baked dough product that has a specific volume that is comparable to dough products that are proofed prior to baking. Examples of such embodiments of the invention can exhibit leavening properties that result in expansion of the dough composition from a raw unproofed state to a volume that is at least or that is greater than 4 times the original unproofed volume, e.g., at least 4.5 times initial unproofed volume, while still achieving other desired bread-like properties such as color texture, taste, and aroma.

Also, various embodiments of raw dough compositions of the invention can be baked directly (immediately or soon after it is formed to a dough piece), or can be formed to a dough piece and then stored at frozen or refrigerated conditions, then baked from storage without a proofing step. Other exemplary finished dough compositions can be stored unproofed and frozen and baked directly from frozen storage without a proofing or a thawing step.

More generally, dough compositions of the invention may include any of various general classes of dough compositions, such as refrigerated doughs, frozen doughs, developed, freezer-to-oven, retarder-to-oven, thaw and bake, etc. According to certain embodiments, the inventive compositions and methods are used with developed, freezer-to-oven dough compositions and related methods. Examples of specific types of dough products or dough pieces include but are not limited to types of doughs sometimes prepared by using a sponge or preferment methods, including bread, breadsticks, boules, baguettes, rolls, buns, pizza crusts, flatbreads, fococcia, bagels, pretzels, croissants, and the like.

Commercial importance of unproofed, oven-ready doughs (e.g., freezer-to-oven dough composition) is considerable. Shipping costs of an unproofed versus a proofed dough product are reduced due to the low initial volume of the product. This translates into less space required for storage or during transit. Current customer preferences for a typical frozen dough product can exclude thawing and proofing before baking. Proofing and thawing steps require time by a user, as well as possibly well-trained employees and expensive space and equipment. Additionally, the time requirements of proofing and thawing steps, as compared to the prospective ease in using an unproofed freezer-to-oven dough, make the concept attractive to most customers.

In the present description, unless otherwise indicated, percentages are in terms of the total weight of a dough composition, e.g., a preferment dough composition or a finished dough composition that includes the preferment dough composition plus all ingredients added to the preferment dough composition. Thus, weight percentages are normally in weight percent of a total dough composition (e.g., preferment dough composition or a final dough composition of preferment and additional dough ingredients) including flour.

In the present description, the term “unproofed” is used as generally understood in the dough and baking arts, e.g., to refer to a dough composition that has not been processed to include timing intended to cause or allow proofing or intentional leavening of a final dough composition; a resting step of a prefermented dough composition is not a proofing step. For example, a final dough composition may not have been subjected to a specific holding stage for causing the volume of the dough to increase by more than 10 percent.

An aspect of the invention relates to a dough composition comprising water; yeast; flour; concentrated protein ingredient; and starch having a low, high-temperature viscosity.

Another aspect of the invention relates to a method of preparing a dough composition. The method includes combining ingredients comprising water, yeast, yeast nutrient, a concentrated protein ingredient. The dough composition contains starch having a low high-temperature viscosity.

### BRIEF DESCRIPTION OF THE DRAWINGS

FIGS. 1, 2, and 3 illustrate high-temperature viscosities in the form of graphed test data prepared using a Rapid Visco Analyzer (RVA) according to AACC Method 76-21).

### DETAILED DESCRIPTION

According to the invention, dough compositions include starch having relatively low, high-temperature viscosity (e.g., “hot viscosity”), and added protein, e.g., in the form of a concentrated protein ingredient.

A “concentrated protein ingredient” as used according to the present description includes a non-flour dough ingredient that contains a substantial concentration of protein, such as gluten or gluten mimetic. A concentrated protein ingredient can be derived from wheat, e.g., in the form of a wheat protein isolate. Other concentrated protein ingredients can be non-wheat ingredients. Such ingredients, including those presently known in the baking arts or developed in the future, include a useful concentration of a protein such as gluten and can be added to the dough composition to improve gas-holding capacity of the dough matrix as described herein.

Non-gluten proteins that may be useful in a concentrated protein ingredient may include proteins such as albumen; casein, casienates; milk proteins such as whey protein, modified whey protein; soy protein; modified soy protein; legume proteins; protein isolates; and the like, any of which may be used alone or in combination with gluten. Certain concentrated protein ingredients can include gluten at a concentration of at least 20% weight percent gluten based on the total weight of the concentrated protein ingredient, e.g., at least 75% weight percent gluten based on total weight of the concentrated protein ingredient. While dough compositions of the invention include wheat flour, and wheat flours can include gluten, a standard wheat flour (including high gluten wheat flour) often used in dough compositions are not considered “concentrated protein ingredients” for purposes of this description. Still, “total protein” in a dough composition, as used herein, includes amounts of gluten that are part of a concentrated protein ingredient, plus amounts of protein that are present due to a wheat flour ingredient (e.g., a high gluten flour).

Vital wheat gluten is an example of a concentrated protein ingredient (here, a “concentrated gluten ingredient”), and normally is an ingredient in the form of a protein powder having the ability to reconstitute rapidly in water to give a homogenous, viscoelastic, coherent mass with similar properties as the native flour protein would possess when washed out in the form of wet gluten. Starch and bran normally present in a wheat flour have been removed from this ingredient. The typical commercial vital wheat concentrated protein ingredient can contain from 75 to 80 percent by weight total protein (of which about 80 percent is gluten in the form of either glutenin or gliadin) 10 percent by weight residual starch, and 5 percent by weight lipid (all dry weight basis), with the remainder being minerals, fiber, and other impurities. Moisture content is typically from 8 to 9 percent based on weight, not normally in excess of 10 percent by weight.

Wheat protein isolate is another example of a concentrated protein ingredient, a purified form of gluten, normally in the form of a dry powder prepared by removing starch from wheat flour and drying the remaining protein fraction. In general, wheat protein isolate ingredients are commercially available having a somewhat higher concentration of protein compared to vital wheat gluten ingredients.

According to the invention, a concentrated protein ingredient can be included as an amount of a dough composition that, in combination with other features and ingredients of the dough composition as described, results in described leavening properties. The concentrated protein ingredient can be included in an amount that provides an amount of total protein in a dough composition in the range from 7 to 20 weight percent protein (e.g., a dough composition may contain from 3 to 25 weight percent concentrated protein ingredient containing from 70 to 80 percent by weight gluten) based on the total weight of the dough composition, with “total protein” including protein of a concentrated protein ingredient plus any amount of protein present due to a flour ingredient or any other dough ingredient. Albumen or other non-gluten proteins can be used (e.g., partially, such as up to 50% non-gluten protein in a dough composition based on total protein) in combination with gluten, but should be considered part of the 7 to 20 weight percent total protein in a dough composition.

One particular type of protein, gluten can exist in at least two forms, including glutenin and gliadin. Glutenin can be defined as gluten that is insoluble in 70 percent aqueous alcohol (e.g., MeOH, EtOH). Gliadin can be defined as gluten that is soluble in 70 percent alcohol. According to certain specific embodiments of the invention, a concentrated protein ingredient can contain a preponderance or more of glutenin, which is believed to have particularly good effects on the mechanical properties of a dough matrix, e.g., between 50 and 80 percent glutenin, and 20 to 50 percent gliadin, based on total gluten.

A concentrated protein ingredient may be added to other ingredients of a dough composition at any useful stage of preparing a final dough composition, such as by combining a concentrated protein ingredient with other ingredients to produce a dough composition or a preferment dough composition, by combining a concentrated protein ingredient with a previously prepared preferment dough composition that has been rested to allow yeast in the preferment dough composition to ferment, or otherwise. According to certain specific embodiments, a concentrated protein ingredient may be included in a preferment dough composition, e.g., as discussed in Applicants' copending United States patent application attorney docket no. PIL0176US (P6441), entitled “DOUGH COMPOSITIONS AND RELATED METHODS, INVOLVING HIGH-GLUTEN CONTENT,” filed on even date herewith, the entirety of which is incorporated herein by reference.

A dough composition of the invention includes starch having relatively low, high-temperature viscosity (“hot viscosity”). Starch can affect Theological properties of a dough matrix during cooking by allowing the dough composition to expand during a cooking (e.g., baking) cycle, up until a point in time during the cycle at which the starch increases in viscosity during gelatinization of the starch as water redistributes from gluten to starch. As the starch gelatinizes, the cell walls of the dough matrix become more flexible and thinner, and will eventually rupture to produce discontinuities in the dough matrix. These discontinuities cause the dough matrix to change from an expandable gas-discontinuous foam to a gas-continuous sponge. When this occurs, the dough matrix is thereafter inhibited or prevented from expanding further during the remaining portion of the cooking cycle. Accordingly, a starch that can maintain a relatively low viscosity during baking can delay the timing during a cooking cycle after which further expansion of the dough is prevented—the use of a starch having a relatively low “hot-viscosity” therefore can extend the time during which a dough composition can experience expansion and can increase the final volume that the cooked dough can achieve.

A starch having a low, high-temperature viscosity may be a component of a particular type of flour that includes the starch, or the starch may be included as a separate (non-flour) ingredient that contains the starch, e.g., a concentrated amount of the starch. The term “starch ingredient” refers to an ingredient that is not a wheat flour and that contains a concentrated amount of starch. While wheat flours include various types of different starches, the term “starch ingredient” is not meant to include wheat flour ingredients such as whole wheat flour, patent flours, soft wheat flours. Still, according to the present description, reference to the total amount of starch having a relatively low high-temperature viscosity will include all such starch in a dough composition, whether added as a non-flour “starch ingredient” or as starch that is included in a dough composition as a component of a wheat flour ingredient (e.g., waxy wheat flour), or as any other ingredient of a dough composition.

Examples of starch ingredients that include starch having a low, high-temperature viscosity can include ingredients known in the dough and bread making arts such as hydrophobic starches; high amylopectin starch source; modified corn starch (e.g., crosslinked, hydroxypropylated, or acetylated corn starches such as hydroxypropylated corn starch having a minimal degree of substitution of 2%); amylopectin (e.g., a concentrated amylopectin starch source); modified wheat starch (e.g., hydroxypropylated wheat starch, oxidized wheat starch, etc.); and combinations thereof.

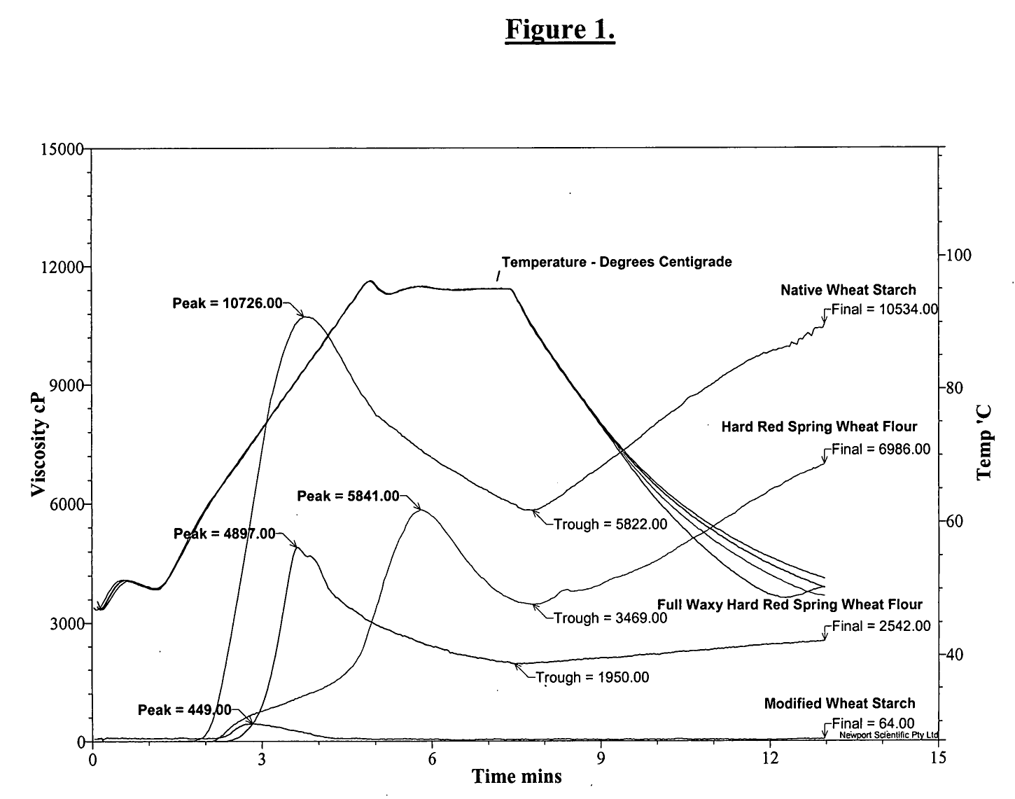

A viscosity of a starch at baking temperature, e.g., a “hot viscosity,” can be measured using a Rapid Visco Analyzer (RVA). A Rapid Visco Analyzer is a device commonly used to evaluate the pasting characteristics of flours and starches, including the swelling, gelatinization, disintegration, and gelling abilities. Standard methods to evaluate starch pasting have been developed and adopted as official methods by the American Association of Cereal Chemists (AACC Method 76-21). The testing methods use a metal sample cup to which water and starch are added. A paddle inserted into the sample cup keeps the starch in suspension over a heating profile. A testing profile typically includes a heating stage, a hold time at the peak temperature, and a cooling profile. See FIG. 1. As the starch slurry is heated, the viscosity changes, and this is measured as a change in torque on the paddle. Generally, as heating begins, there is an initial increase in viscosity when the starch granules swell. “Peak viscosity” is observed when all of the starch granules have swollen to their greatest extent without losing their integrity; the term “peak viscosity” refers to this initial maxima in viscosity that typically occurs during the heating or constant temperature regime of testing according to AACC Method 76-21. During the hold time at the peak temperature, the granules lose their integrity, a stage known as “pasting.” At this point, viscosity decreases. As the cooling stage begins, starch polymers begin to reassociate and thus increase the viscosity of the paste. This increase in viscosity is commonly known as the term “set-back.”

Examples of types of starch that have been found to exhibit a desirably low viscosity at high temperature include amylopectin, modified wheat starch, and modified corn starch. Modified starches may be modified in any manner to exhibit desired rheology as described herein (by exhibiting a relatively low, high-temperature viscosity), e.g., modified to be acid-thinned or to be oxidized. An example of a type of flour that includes starch having a low high-temperature viscosity is amylopectin found in waxy wheat flour, e.g., full waxy wheat (hard spring or hard winter) flour.

FIGS. 1, 2, and 3 illustrate high temperature viscosities in the form of graphed test data performed using a Rapid Visco Analyzer (RVA) according to AACC Method 76-21). The graphs show differences in the time at which peak viscosity occurs for certain flours and starches, and also shows differences in the values of the peak viscosities.

Referring to FIG. 1, this figure shows relatively lower high-temperature viscosity measurements for full waxy hard red spring wheat as compared to hard red spring wheat, and for modified corn starch relative to native wheat starch. The peak viscosity in the RVA method occurs at 3.6 minutes for the full waxy wheat flour and 5.8 minutes for a standard hard red spring wheat flour.

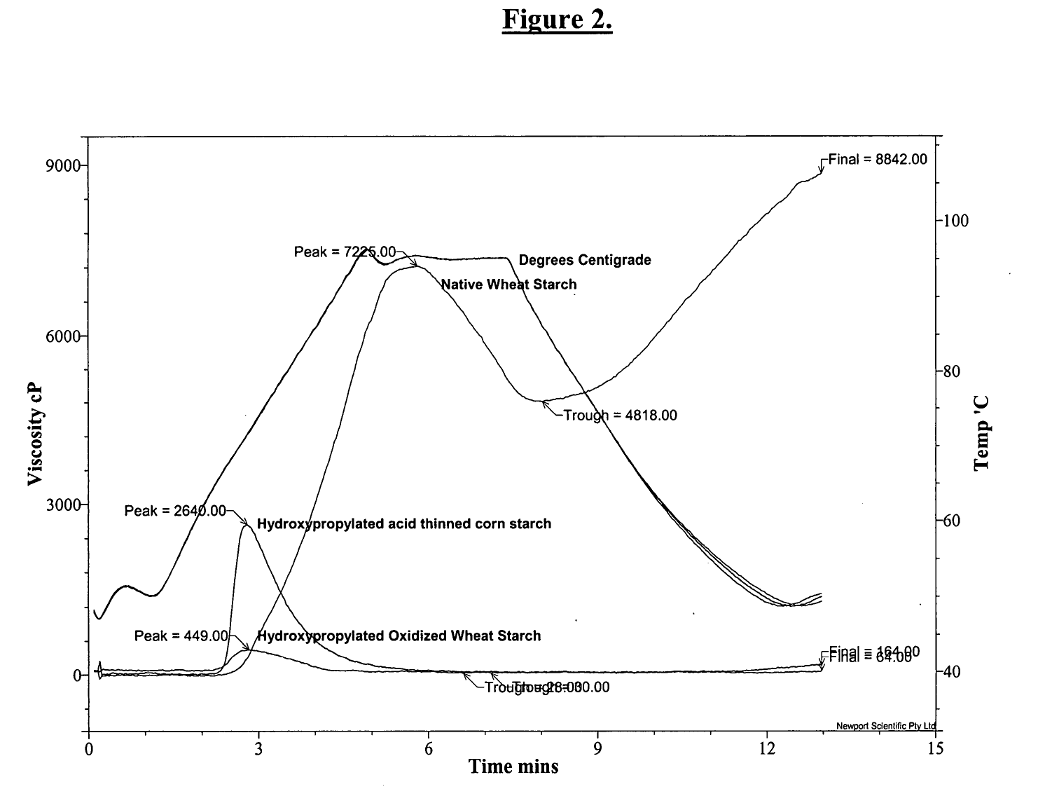

FIG. 2 also illustrates the feature of certain starches of the invention that desired starches can exhibit relatively earlier peak viscosities, and, relatively earlier trough viscosities when tested according to AACC Method 76-21, as compared to conventional starches such as native wheat starch. A trough viscosity is the substantial viscosity reduction, or breakdown, that occurs after peak viscosity. Surprisingly, early peak and trough viscosities compared to standard starches and flours have been found to produce doughs with desirable or even improved expansion properties during cooking (e.g., baking). For example, starches and flours that exhibit relatively early peak and trough viscosities compared to standard starches and flours can exhibit relatively greater baked specific volumes.

As a possible reason for the desirable dough expansion properties of doughs that contain starches having relatively early peak and trough viscosities when tested by AACC Method 76-21, these starches and flours may be experiencing increased granule flexibility due to decreased granule integrity (partial pasting). A test sample exhibits substantial breakdown or a trough in viscosity when transitioning through the “paste” stage of the tested sample, after experiencing a peak viscosity. It may be desirable for a starch to experience a partial paste stage at a baking temperature, during a baking cycle, at a time when the reduced viscosity can advantageously affect dough rheology and the related expansion properties. Starches tested using the AACC Method 76-21 are in an environment of excess water, resulting in the loss of starch granule integrity to a greater degree than in a lower moisture dough. With lower moisture present, the granules retain their integrity to some degree and do not completely paste, but still provide a lower viscosity than that of native wheat starch. Earlier partial pasting of starch contained in a dough composition (e.g., at a lower temperature when tested using AACC Method 76-21), such as partial pasting during a portion of the baking cycle when a dough experiences expansion, seems to result in interference of the native wheat starch granule interaction with itself that allows for an increased opportunity for a dough composition to expand during baking, and increased overall expansion of a dough, with an increased baked specific volume being a result.

Referring to FIG. 1, the peak viscosities of waxy wheat flour and modified corn starch are lower compared to native wheat starch and hard red spring wheat flour, respectively, and also occur earlier. Additionally, the substantial reduction in viscosities after peak, or “trough” viscosities, of the waxy wheat flour and modified corn starch occur relatively earlier during the test and at a lower temperature in the temperature cycle. This may help explain the observation that unproofed frozen doughs made from waxy wheat flours exhibit rapid expansion at the back half of the bake cycle, as opposed to consistent expansion throughout the bake cycle. Similar observations are made in the comparison of native wheat starch and modified corn starch and modified wheat starch (hydroxypropylated acid-thinned corn starch and hydroxypropylated oxidized wheat starch) (see FIG. 2). As shown in FIGS. 1 and 2, the modified corn starch and modified wheat starch exhibit substantially reduced increases in viscosity during the heating profile when tested when tested according to AACC Method 76-21, i.e., relatively lower peak viscosities, as compared to the dramatic increase in viscosity of the native wheat starch.

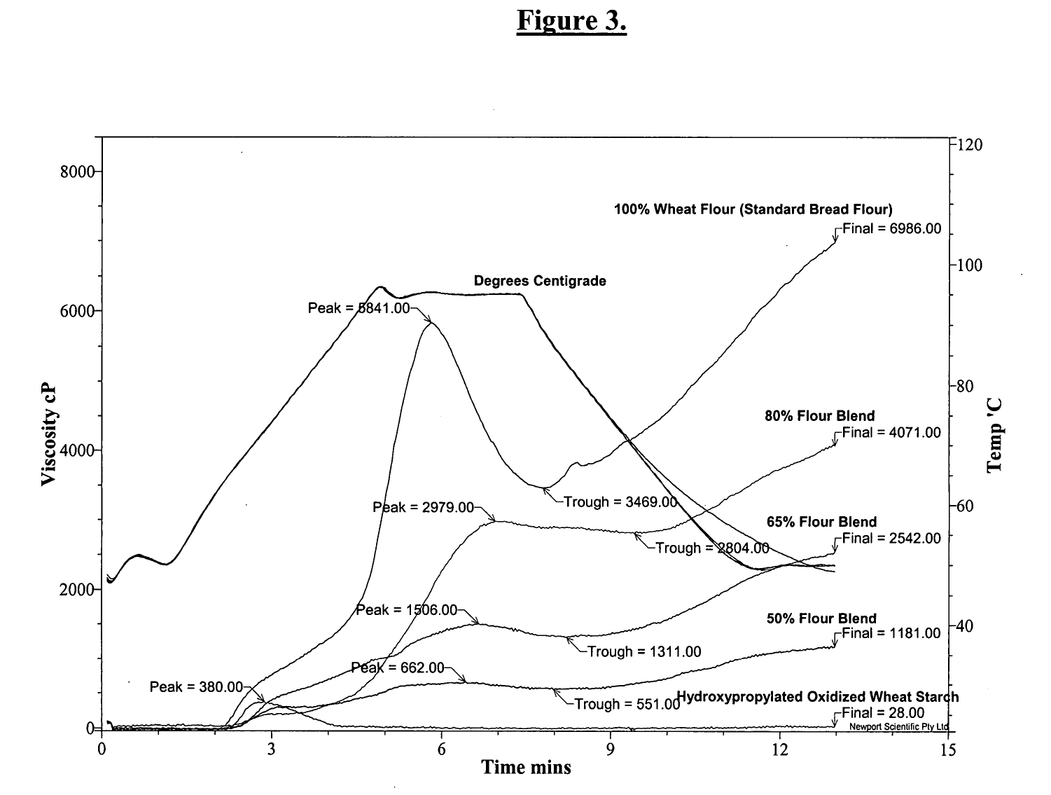

FIG. 3 shows RVA data of native wheat flour (“flour”) and various blends of native wheat flour and hydroxypropylated oxidized wheat starch. As is shown, blends that combine the flour and the modified wheat starch can exhibit desired low, high-temperature viscosities.

In general, a “low” high-temperature viscosity of any particular flour, starch, or blend of flour and starch, as described according to the invention, can be any high-temperature viscosity that provides desired properties in a dough composition, such as desired or improved leavening properties. As exemplary ranges, useful low, high-viscosities of certain exemplary starches, flours, and combinations of starch and flour are shown in FIGS. 1, 2, and 3. As illustrated, desirable peak viscosities of starches and flours useful to provide starch having desirable low, high-temperature viscosity, when measured using AACC method 76-21, may be below or substantially below the peak viscosity for native wheat starch, as illustrated in FIG. 2 (i.e., 7225 cP), or below the peak viscosity for hard red spring wheat flour as illustrated in FIG. 1 (i.e., 3469 cP), respectively.

Exemplary starch ingredients exhibiting low high-temperature viscosity (e.g., modified corn starch, modified wheat starch) can exhibit a peak viscosity no greater than 5000 centipoise (cP), e.g., below 3000 cP, and even below 1500 cP or 500 cP, when measured using AACC method 76-21. Exemplary starch ingredients exhibiting low high-temperature viscosity (e.g., modified corn starch, modified wheat starch) can exhibit a peak viscosity that occurs in less than 3 minutes, e.g., in less than 2.5 minutes, when measured using AACC method 76-21.

Flours that contain starch having a low, high-temperature viscosity, according to the invention, can exhibit a peak viscosity at temperatures lower than that of a standard bread-making flour, e.g., less than 85° C. (See FIG. 1.) These flours may also demonstrate a relatively lower viscosity after peak in the RVA test as described over the range of temperatures where native wheat starch exhibits peak viscosity; e.g., about 95° C. Exemplary flours (e.g., waxy wheat flour) that contain starch having a low high-temperature viscosity (e.g., amylopectin) can exhibit a peak viscosity no greater than 5000 cP, e.g., below 3000 cP, and even below 1500 cP or 500 cP, when measured using AACC method 76-21. Exemplary flours that contain starch having low, high-temperature viscosity (e.g., waxy wheat flour) can exhibit a peak viscosity that occurs in less than 5 minutes, e.g., in less than 4 minutes, when measured using AACC method 76-21.

With respect to useful blends of flour and starch, exemplary dough compositions of the invention can include flour and starch components, together in combination, that exhibit a low high-temperature viscosity, as described herein. Certain embodiments of the invention can include the use of a combination of separate starch ingredient and flour ingredient wherein the total amount of starch and flour ingredients, when combined and tested, exhibits a desirable, relatively low high-temperature viscosity. (Other embodiments of the invention can contain flour (e.g., waxy wheat flour) and no additional starch ingredient.) The total amount of starch and flour refers to the total amount of all flour ingredients in a dough composition and all starch, whether or not a starch itself exhibits a low high—temperature viscosity, whether or not a flour includes starch that by itself exhibits low high-temperature viscosity, and whether or not the dough composition does not contain any starch ingredient at all (but instead contains, e.g., waxy wheat flour and no additional starch ingredient). In general, as the proportion of starch in relation to flour increases, the slower the rate of viscosity increase, and the lower the peak viscosity obtained.

Exemplary blends of total amounts of flour and starch contained in a dough composition can exhibit a peak viscosity no greater than 4900 cP, e.g., below 3000 cP, and even below 1500 cP or 500 cP, when measured using AACC method 76-21.

Starch, generally, can be included in a dough composition by any mode, for example by being present as a component of any dough ingredient such as a type of wheat flour that includes starch, a non-wheat flour that includes starch, or any non-flour starch ingredient. Starch that exhibits a low high-temperature viscosity may be added to a dough composition of the invention at any useful stage of preparation, such as by combining such a starch (e.g., in the form of a wheat flour or a non-wheat flour starch ingredient) with other ingredients in a straight-dough method or to produce a preferment dough composition, or by combining such a starch (e.g., in the form of a wheat flour or starch ingredient) with a preferment dough composition as an additional dough ingredient after the preferment dough composition has been rested. According to certain embodiments that involve the use of a preferment dough composition, a starch that exhibits a relatively low viscosity at high temperature may be effective if included in the final dough mix as opposed to the preferment mix or an intermediate mixing step. Addition of the starch at a later stage in preparation of a dough composition allows protein in the dough composition to hydrate before other ingredients.

An amount of starch having a relatively low high-temperature viscosity can be included in a dough composition in an amount that, in a dough composition having other ingredients and features as described herein, results in desired or improved leavening properties as described. The particular amount of such a starch that is included in any specific dough composition can depend on factors such as the type of dough product, the desired rheology of a dough matrix, desired leavening properties of the dough during processing and cooking, and types and amounts of other dough ingredients. An exemplary range of amounts of starch having a relatively low high-temperature viscosity can be in the range up to 30 weight percent of such starch based on the total weight of a dough composition, e.g., from 5 or 10, up to 15 weight percent of such starch based on the total weight of a dough composition.

A dough composition of the invention can also include other starch that does not have a relatively low high-temperature viscosity. In specific exemplary embodiments, a dough composition can include a total amount of all starch that is from about 0 to 20 percent native wheat starch from wheat flour having a Peak viscosity of greater than 5000 cP at a peak time of greater than 3.75 minutes and a trough viscosity of at least 3300 cp when measured using AACC method 76-21, which is not considered to be a relatively low high-temperature viscosity, and from about 80 to 100 percent by weight of a starch that does exhibit a relatively low high-temperature viscosity, e.g., as provided by full waxy wheat flour; or as provided by a starch ingredient such as a modified wheat starch ingredient, a modified corn starch ingredient, (e.g., hydroxypropylated acid-thinned corn starch) an amylopectin or starch ingredient, etc., or another starch ingredient that exhibits a relatively low, high-temperature viscosity such as a peak viscosity less than 5000 cP at a peak time of less than 3.75 minutes and a trough viscosity less than 2500 cp when measured using AACC method 76-21.

In addition to the starch and concentrated protein ingredients, dough compositions according to the invention can be prepared from ingredients known in the dough and bread-making arts, typically including flour, yeast, a liquid component such as oil or water, and optionally additional ingredients such as shortening, salt, sweeteners, dairy products, egg products, processing aids, emulsifiers, particulates, dough conditioners, flavorants, etc.

A flour useful in a dough composition can be any suitable flour or combination of flours, such as wheat flour that may be hard wheat winter or spring flour, with protein ranges of from about 10 weight percent to about 16 weight percent protein, based on the weight of the flour. A high protein flour (containing between about 12 and about 16 weight percent protein) may be useful, as can be a flour that contains starch having a relatively low high-temperature viscosity (e.g., amylopectin), such as a partial or full waxy wheat flour.

Yeast can be in the form of a yeast ingredient such as any one or more of those sometimes referred to as fresh crumbled yeast (also called cake yeast or compressed yeast); yeast cream; a dry yeast such as instant dry yeast, dry active yeast, protected active dry yeast; frozen yeast; and combinations of these. Yeast ingredients such as these can differ in the amount of moisture they contain, which can in turn influence how much of a particular yeast ingredient should be included in a dough composition. Some yeast ingredients have a high moisture content (e.g., greater than 60% by weight). These high moisture yeast ingredients include those yeast ingredients sometimes referred to as fresh crumbled yeast, cake yeast, compressed yeast, and yeast cream. Other yeast ingredients can include lower amounts of moisture, e.g., less than 10 percent by weight moisture (generally 2 to 8 weight percent moisture), and include yeast ingredients sometimes designated “dry” yeast ingredients, e.g., active dry yeast and instant dry yeast. The moisture content of a yeast ingredient can affect the total amount of a yeast ingredient included in a dough composition. Different amounts of a dry yeast ingredient (including water in a lower amount) would be needed compared to higher moisture content yeast ingredient such as fresh crumbled yeast, cake yeast, or compressed yeast. (The term “yeast ingredient,” e.g., when used to describe amounts of yeast in a dough composition, is used herein to refer to yeast in a form that includes the moisture content of the yeast ingredient.) The dough composition can also include one or more liquid components.

Examples of liquid components include water, milk, eggs, and oil, or any combination of these. Water may be added during processing in the form of ice, to control the dough temperature in process; the amount of any such water used is included in the amount of liquid components. The amount of liquid components included in any particular dough composition can depend on a variety of factors including the desired moisture content of the dough composition. Typically, liquids can be present in a dough composition in an amount between about 15% by weight and about 35% by weight, e.g., between about 20% by weight and about 30% by weight.

The dough composition can optionally include fat ingredients such as oils and shortenings. Examples of suitable oils include soybean oil, corn oil, canola oil, sunflower oil, and other vegetable oils. Examples of suitable shortenings include animal fats and hydrogenated vegetable oils.

The dough composition can optionally include various other liquid or dry ingredients, as will be understood, such as egg products or dairy products, e.g., milk, buttermilk, or other milk products, in either dried or liquid forms. Alternatively, milk substitutes such as soy milk may be used. Alternately or in addition, the dough composition can optionally include one or more sweeteners, either natural or artificial, liquid or dry; salt, such as sodium chloride and/or potassium chloride; whey; malt; yeast extract; inactivated yeast; spices; vanilla; natural and artificial flavors; or particulates such as raisins, currants, fruit pieces, nuts, seeds, vegetable pieces, and the like, in suitable amounts.

As is known, dough compositions can also optionally include other additives, colorings, and processing aids such as emulsifiers include lecithin, mono- and diglycerides, polyglycerol esters, and the like, e.g., diacetylated tartaric esters of monoglyceride (DATEM) and sodium stearoyl-2-lactylate (SSL).

Conditioners, as are known in the dough products arts, can be used to make the dough composition tougher, drier, and/or easier to manipulate. Examples of suitable conditioners can include azodicarbonamide, potassium sulfate, L-cysteine, sodium bisulfate and the like. If used, azodicarbonamide is preferably not present in an amount more than 45 parts per million.

Optionally, an enzyme such as transglutaminase can be included in a dough composition according to the invention to further strengthen the dough composition by creating links between proteins in the preferment dough composition matrix. The transglutaminase may be added to a preferment dough composition prior to resting, or later, or may be combined with other dough ingredients in a straight-dough preparation method.

An enzyme such as transglutaminase may be included in any amount effective to provide a desired strengthening effect, to the preferment dough composition or otherwise. Exemplary amounts included in a dough composition may be, for example, up to 300 parts transglutaminase by weight, per million parts total weight dry ingredients of the finished dough composition.

Optionally, a hydrocolloid may be another ingredient included in a dough composition of the invention, e.g., included as an ingredient of a preferment dough composition, added to a rested preferment dough composition, or combined with other ingredients a part of using a straight-dough preparation method. Hydrocolloid may be included to modify the viscosity of a dough matrix to further provide desired mechanical, Theological, or leavening properties of a preferment dough composition or a finished dough composition. For example, a hydrocolloid may be included in a preferment dough composition in an amount effective to modify the size of bubbles present in the preferment dough composition, as desired. Examples of useful hydrocolloid materials can include xanthan, guar, locust bean, agar, gallant, propylene glycol alginate, or any other hydrocolloid used or useful in a bread formulation. Such materials may be included in a preferment or a finished dough composition in any desired or useful amounts, which may vary depending on the type of hydrocolloid selected. As an example, guar may be included in a preferment dough composition in amount in the range from 0.01 to 1 weight percent guar based on the total weight of a preferment dough composition; propylene glycol alginate may be included in an amount in the range from 0.01 to 0.1 weight percent propylene glycol alginate based on the total weight of a preferment dough composition.

Dough compositions of the invention can be formed in any suitable manner consistent with the present description, such as by steps included in methods generally understood and referred to as “sponge” or “preferment” methods, as well as methods referred to as “straight-dough” methods.

According to straight-dough methods, flour and other dry ingredients can be combined with a fat component, if used, and then combined with a yeast slurry (if a dry yeast is used) or with a pre-hydrated yeast. All ingredients are generally mixed together using any of a variety of methods and/or addition orders as are known in the dough-making arts, to form a raw dough composition. Mixing may be performed in commercially available and well-known equipment, for example a horizontal bar mixer with a cooling jacket. The dough composition is generally mixed between about 5 minutes and about 15 minutes or until a proper consistency is achieved.

Certain embodiments of doughs of the invention are prepared by preferment methods, whereby a “preferment” or “sponge” method. Steps of preparing such a dough composition can include first, preparation of the “preferment” or “sponge” composition, a step that allows yeast of the preferment composition to ferment, and a step of adding additional dough ingredients to the prefermented dough composition to produce a final dough composition.

These embodiments of dough compositions can be prepared by providing a prefermented dough composition (e.g., those sometimes referred to as, e.g., a “sponge,” “preferment,” “preferment composition,” or “preferment dough composition,” “poolish,” etc.) and adding additional dough ingredients to that preferment dough composition, wherein the finished or final dough composition includes a starch having a relatively low, high-temperature viscosity as well as an elevated protein level. The preferment may contain a high amount of protein, e.g., based on inclusion of a concentrated protein ingredient, and may include starch having a relatively low high-temperature viscosity, or both, but either one or both of these types of ingredients may alternately or additionally be added into a dough composition of the invention in the form of an additional ingredient that is combined with a preferment composition after the preferment composition has been rested to allow yeast of the preferment composition to metabolize and ferment.

A preferment composition generally includes ingredients useful to provide a preferment dough composition having an extensible sponge matrix that contains water, yeast, yeast food, and flour. The yeast becomes metabolically active during steps of preparing or resting the preferment composition and produces carbon dioxide and other metabolites that form bubbles in the matrix and that can become absorbed by an aqueous component of the preferment composition. The preferment composition takes the form of a developed dough matrix being interrupted by a large amount of bubbles (or “cells”) containing carbon dioxide and water vapor. Thus, a preferment dough composition of the invention can be prepared by combining ingredients including at least yeast, water, a yeast nutrient, and optionally added protein such as a concentrated protein ingredient, a low, high-temperature starch ingredient, or both. These ingredients are combined in an acceptable manner to produce a preferment dough composition.

A preferment composition can include an amount of flour effective to provide desired structure and consistency, e.g., structure and consistency that allow for fermentation of yeast, expansion of the preferment composition, and formation of bubbles. Such useful amounts are generally known in the dough and bread making arts. Exemplary amounts of total flour in a preferment composition can be in the range from 40 to 70 weight percent flour based on the weight of the sponge, but may be lower according to specific embodiments of the invention, e.g., from 2 to 20 weight percent flour based on the total weight of a preferment, or from 8 to 12 weight percent flour based on the weight of the sponge.

Yeast is included in a preferment composition to produce metabolites, especially gaseous metabolites such as carbon dioxide. The amount of yeast included in a preferment dough composition can be an amount that will produce a desired volume of metabolites (e.g., carbon dioxide) to in turn cause the preferment composition to produce bubbles and to develop and strengthen, optionally an amount sufficient to also cause carbon dioxide to be absorbed by water in the sponge, even to produce a water component that is saturated with absorbed carbon dioxide. Yeast can be in the form of a yeast ingredient such as any one or more of fresh crumbled yeast (also called cake yeast or compressed yeast); yeast cream; a dry yeast such as instant dry yeast, dry active yeast, protected active dry yeast; frozen yeast; and combinations of these, and can be included in any useful amount.

Exemplary amounts of yeast in a preferment, in terms of compressed yeast, can be amounts within the range from 2 to 20 weight percent, e.g., from 8 to 12 weight percent compressed yeast ingredient (including the water component of the ingredient), based on a total weight of a preferment composition. Other yeast ingredients that have similar moisture content can be used in these same ranges. Yeast ingredients that have different (higher or lower) percent moisture can be used as an early stage yeast portion in higher or lower amounts (respectively), but still in amounts that will provide the same or similar amount of the yeast component (yeast cells) of the yeast ingredient. According to certain embodiments of the invention, the total amount of the yeast ingredient that will be included in a final dough composition can be added to the preferment composition, meaning that no additional yeast is added as an additional dough ingredient after the preferment composition has been rested or fermented.

A preferment dough composition may optionally also include some form of yeast nutrient, which is an ingredient that can be metabolized by the yeast to produce a preferment dough composition. A yeast nutrient can be a nutrient that is useful with a particular yeast, whereby the yeast and its enzymes can metabolize the nutrient to produce metabolites. A yeast nutrient can be included as a constituent of a flour that is included in a preferment composition, or may be added as a separate ingredient such as a sugar. A single example of useful non-flour yeast nutrient is a class of sugars generally known to act as yeast nutrients, including dextrose.

The amount of yeast nutrient included in a preferment dough composition can be any amount that is useful for the amount of yeast, to produce a desired amount of metabolites, as will be understood by a skilled artisan. Examples of useful amounts of non-flour yeast nutrient, such as a sugar, that can be included in a preferment composition can be an amount in the range from 1 to 10 weight percent yeast nutrient based on the total weight of the preferment composition, e.g., from 3 to 6 percent by weight based on the total weight of the preferment composition.

A preferment dough composition can include liquid water in an amount that, with the other ingredients, will produce a sponge having useful properties of a sponge, including useful structure and consistency, i.e., structure and consistency that allow for fermentation of yeast, expansion, and formation and retention of bubbles. The amount of water in any particular preferment composition should be an amount that wets out the ingredients and provides a preferment dough composition having sufficient strength and cohesion to maintain bubbles formed upon evolution of gaseous metabolites such as carbon dioxide, e.g., in a closed cell structure of a dough matrix containing bubbles of carbon dioxide. Exemplary amounts of water in a sponge dough composition can be at least about 40 to 60 weight percent water based on the total weight of the preferment dough composition, e.g., an amount in the range from about 50 to 60 weight percent water based on total weight of the preferment dough composition.

If a concentrated protein ingredient is included in a preferment composition, the concentrated protein ingredient can be included in any desired or useful amount to produce a finished dough composition having a total amount of protein that will exhibit leavening properties as discussed herein. Examples of useful amounts of concentrated protein ingredient (e.g., vital wheat gluten having a moisture content of 20 to 30 percent by weight) that can be included in a preferment composition, may be in the range from 6 to 40 percent by weight concentrated protein ingredient based on total weight of a preferment composition, e.g., from 15 to 25 weight percent concentrated protein ingredient based on total weight of a preferment dough composition.

According to certain specific embodiments of the invention, a total amount of protein in a preferment dough composition, based on protein found in a flour ingredient or in a non-flour concentrated protein ingredient (e.g., vital wheat gluten, etc.) can be in the range from 4 to 35 weight percent, e.g., from 10 to 25 weight percent.

A preferment dough composition or a finished dough composition of the invention may include other optional ingredients, as will be understood by the skilled artisan, including amounts of flavoring, sugar, shortening (oil or plastic), water-binding agent (e.g., hydrocolloid), or additives or preservatives, as discussed elsewhere in this disclosure. These ingredients can be included in the preferment composition in amounts that will produce a sponge as described above.

The following table lists exemplary amounts of certain ingredients that may be include in a sponge or preferment, according to the invention:

| | Weight percent, based |
|---|---|
| INGREDIENT | on total weight sponge |
| Flour (total) | up to 50 |
| Starch ingredient, including starch having a | up to 20 |
| relatively low high-temperature viscosity | |
| Concentrated Protein Ingredient | 0 to 40 |
| Water | 40 to 80 |
| Yeast (compressed) | 2 to 20 |
| Sugar | 0 to 10 |
| | Weight percent of |
| | ingredient based |
| | on total |
| | ingredients above |
| Amount of starch in a preferment dough | 0-30 |
| composition, having a relatively low high- | |
| temperature viscosity - including any amount | |
| in a non-flour “starch ingredient” plus | |
| any amount in a flour such as waxy wheat flour. | |
| Amount of total protein in sponge - including | 8 to 35 |
| any amount in a “concentrated protein | |
| ingredient,” plus any amount in | |
| a flour ingredient. | |

Ingredients used to prepare a preferment dough composition can be combined in any useful manner that allows the preferment dough composition to be produced and processed to contain bubbles and a dough matrix having good gas-holding capacity and leavening properties. The preferment composition can be prepared and processed to allow protein from a concentrated protein ingredient (e.g., gluten) to become hydrated, and to allow yeast to ferment, e.g., pre-ferment, to produce a preferment dough composition that contains carbon dioxide in the form of bubbles in the matrix, and absorbed in water of the dough composition. The composition can be allowed to ferment by resting or otherwise maintaining the preferment dough composition at conditions effective to cause yeast fermentation, typically while the dough composition is maintained in a stationary and still position. Temperatures that can be useful to rest the preferment dough composition can be in the range from about 45 to 95 F, e.g., from about 60 to about 80 F. In some embodiments, the preferment dough composition can be left at room temperature for a time in the range from 15 minutes to 2 hours.

A goal of fermenting the dough composition can be to produce a preferment dough composition with a high concentration of carbon dioxide, including gaseous carbon dioxide and carbon dioxide dissolved in water, and a developed dough matrix that will exhibit high viscoelasticity and therefore increase the number of bubbles retained during mixing in additional ingredients to product a finished dough composition. Additional ingredients are subsequently added to the rested preferment dough composition, and the combined ingredients are processed to produce a final or finished dough composition. Bubbles and carbon dioxide present in the preferment dough composition are transferred to the final dough. The carbon dioxide and bubbles later contribute to expansion of the dough composition during baking and increase the baked specific volume of the baked dough product.

Thus, embodiments of dough compositions according to the invention can be prepared by combining a prefermented sponge composition, as described above, with additional dough ingredients, to produce a final dough composition that contains many ingredients known in the dough and bread-making arts, typically including flour, yeast, a liquid component such as oil or water, and optionally additional ingredients such as shortening, salt, sweeteners, dairy products, egg products, processing aids, emulsifiers, particulates, dough conditioners, flavorants, etc. The final dough composition also includes amounts of gluten and starch having a low, high-temperature viscosity temperature, as described.

A final dough composition (prepared by any method) may include, for example, ingredients in the following amounts: flour in an amount between about 10 percent to about 40 percent by weight flour based on the total weight of the dough composition e.g., from 20 to 30 weight percent flour; water in an amount between 25 and about 50 percent by weight of the total dough composition, e.g., from 30 to 40 weight percent water; total protein (from all ingredients) of from 7 to 20 percent by weight, including at least 50 weight percent of the total protein being gluten; sugar or another sweetener in an amount in a range of between 1 and about 12 percent by weight of the total dough composition, e.g., from 2 to 5 weight percent; and fat (shortening or oil) in a range from 0 and 6 percent by weight of the total dough composition, e.g., from 3 to 5 weight percent fat. Other ingredients such as flavorings, salt, and additives and preservatives can also be included as will be understood.

Thus, for doughs prepared by a straight-dough method, combinations of ingredients can be combined in total amounts as described. For doughs prepared by a preferment method, a preferment dough composition can be prepared as described, and additional dough ingredients can be combined with the prefermented dough composition to provide a final dough composition having the described amounts of ingredients including water, flour, yeast, concentrated protein concentrated protein ingredient, starch and starch having a relatively low, high-temperature viscosity, etc., as well as other ingredients that will be appreciated. The amounts of the additional dough ingredients that are combined with a preferment can be amounts that will result in a dough composition that includes amounts of ingredients described herein, and that will result in a final dough composition that exhibits leavening properties as described.

Examples of total amounts of ingredients in a final dough composition of the invention, can be as follows:

Exemplary Ingredients in Dough Composition
(prepared by any method)

| | Weight percent, based on total |
|---|---|
| INGREDIENT | weight dough composition |
| Flour (total) | 10 to 40 |
| Total starch having a low | 5 to 30 |
| high-temperature viscosity | |
| Total protein (at least 50 weight percent of | 7 to 20 |
| all protein being gluten) | |
| Water | 10 to 50 |
| Yeast Ingredient (compressed) | 1 to 6 |
| Sugar | 1 to 12 |
| Transglutaminase | 0 to 300 ppm |
| Hydrocolloid | 0 to 4 |

Dough compositions of the invention can be types of dough compositions that are typically prepared using a “sponge” or other type of “preferment” method, or a straight-dough method. Examples include developed doughs such as bread doughs such as bread loaves or rolls, croissants, pizza crusts, bagels, pretzels, and the like. Advantageously, doughs of the invention can be prepared into an unproofed dough (e.g., having a raw specific volume in the range from 0.9 to 1.1 cubic centimeters per gram) and baked directly from the unproofed state without a proofing step or a partial proofing step, and without partial baking. The unproofed dough may be stored at refrigerated or frozen conditions, and baked without proofing, optionally without thawing for a frozen dough, to a useful baked specific volume that may be comparable to similar doughs that require any one or more o proofing, partial proofing, or partial baking.

Examples of amounts of certain ingredients useful to produce dough compositions, in terms of preferment and final dough compositions, include ingredients listed in the following table (these amounts are not exclusive of other ingredients):

| | | | Total Dough | |
|---|---|---|---|---|
| | | | Compositions | |
| | | | (prepared by | |
| | Preferment | | any method) | |
| | Useful | Specific | Useful | Specific |
| Water | 40-80% | 60-70% | 25-50% | 30-40% |
| Yeast (compressed) | 2-20% | 8-12% | 1-6% | 2.5-4.5% |
| Yeast food | 1-10% | 3-6% | 1-12% | 2-5% |
| Flour | 2-20% | 8-12% | 10-40% | 20-30% |
| Concentrated protein | 0-40% | 15-25% | 3-20% | 8-12% |
| ingredient | | | | |
| Ingredient containing | 0% | 0% | 0-30% | 10-15% |
| starch (“starch | | | | |
| ingredient”) having a | | | | |
| low “high-temperature | | | | |
| viscosity” | | | | |
| Transglutaminase | 0-300 ppm flour | 50-100 ppm | 0-300 ppm flour | 50-100 ppm |
| | basis | flour basis | basis | flour basis |
| Hydrocolloid | 0-2% | 0.5-1.0% | 0-4% | 1-2% |
| Fat (shortening or oil) | 0% | 0% | 0-6% | 3-5% |
| Salt | 0% | 0% | 0-2% | 1-1.5% |
| Emulsifiers (SSL, | 0% | 0% | 0-0.8% | 0.3-0.5% |
| DATEM, etc.) | | | | |
| Oxidant (ascorbic acid) | | | 0-0.01% | .0025-0.075% |
| Total protein (at least | 6-40% | 15-25% | 7-20% | 9-13% |
| 50% gluten) (calculated | | | | |
| as protein contained in | | | | |
| flour and concentrated | | | | |
| protein ingredient) | | | | |
| Total amount of | 0% | 0% | 5-30% | 8-12% |
| starch having a low “hot | | | | |
| viscosity” (from any | | | | |
| “starch ingredient” plus | | | | |
| flour) | | | | |

Specific embodiments of the dough compositions of the invention can be leavened without the assistance of a chemical leavening system, which means chemical ingredients such as an acid and base that must contact each other and produce a chemical reaction to produce a leavening gas, generally carbon dioxide, which caused a dough to expand. Instead, dough compositions of the invention can be leavened during cooking (e.g., baking) based on the presence of carbon dioxide bubbles, absorbed carbon dioxide, water vapor, etc., that is present in the dough during baking based on the fermentation of the sponge. Because of the strengthened dough composition resulting from protein in the finished dough composition, and the use of a starch having a relatively low high-temperature viscosity, embodiments of finished dough compositions of the invention can expand during baking to a volume that may be 3.5, 4, or 4.5 times the original unproofed volume.

The actual baked specific volume of any particular dough product of the invention can depend on various factors such as the type of dough product, the use of selected processing steps as described herein, relative amounts of ingredients, and the exact dough formulation. Exemplary baked specific volumes of dough product prepared according to the invention, can be at least about 4 cubic centimeters per gram (cc/g), e.g., at least about 4.5 cc/g, even up to or in excess of 5.5 or 6 cc/g. The baked specific volume of a baked dough product will depend greatly on the composition of the dough composition and the type of dough product it is composed to produce, e.g., a bread loaf, a roll, a sweet roll, a pizza crust, Danish, etc.

Thus, such dough compositions can be baked to baked specific volumes that are typical and conventional in the baking industry of useful yeast-leavened dough products, including pre-proofed or thawed-and-proofed yeast-leavened dough products. But, because certain exemplary dough compositions of the invention do not require a proofing step, the doughs can be useful as unproofed freezer-to-oven doughs, as unproofed retarder-to-oven dough, or as dough compositions that can be directly cooked following preparation, without the need for a proofing step or partial baking step, and optionally without the need for chemical leavening agents.

### EXAMPLE

The following dough composition was prepared using a straight-dough method, as described, to include starch having a low, high-temperature viscosity and concentrated protein ingredient. After preparation and shaping, a glaze was place at the surface of the dough pieces to keep dough surface flexible during baking and prevent premature crust formation to reduce or prevent excessive cracking of the crust during baking.

| Ingredient | % |
|---|---|
| Water | 32.35% |
| Arise 8000 WPI (MGP, Inc.) | 9.70% |
| Midsol 35 (MGP, Inc) | 14.55% |
| Flour | 32.80% |
| Salt | 1.20% |
| Sugar | 1.97% |
| Shortening | 1.96% |
| Lecithin | 0.49% |
| Propylene glycol alginate (PGA) | 0.11% |
| Yeast (crumbled) | 4.38% |
| DATEM | 0.21% |
| Ascorbic Acid | 0.01% |
| Azodicarbonamide (10%) | 0.02% |
| Sodium Stearoyl Lactylate (SSL) | 0.25% |
| Total | 100.00% |

| Glaze Formula | |
|---|---|
| Ingredient | % |
| Water | 68.3 |
| Soy Oil | 25 |
| Sweet Whey Solids | 5 |
| SSL | 1 |
| Guar | 0.7 |
| Total | 100 |

Mixing and Molding Process
1. Preblend Flour, Starch, Wheat protein isolate, salt, sugar, PGA, DATEM, Ascorbic acid, Azodicarbonamide, SSL
2. Add Preblend, lecithin, yeast, and water (35% as ice) to jacket cooled horizontal bar mixer
3. Mix at 36 rpm for 30 seconds to incorporate
4. Mix at 76 rpm until dough has reached 60-70% development as determined by measurement of total energy to peak development
5. Add shortening to mixer
6. Mix to peak development
7. Use a Konig Automat Micro divider/rounder to produce rolls at target weight (42 g)
8. Place dough pieces on parchment lined pans
9. Freeze individual dough pieces at −35 F for one hour
10. Transfer product into −10 F freezer for storage
   Glaze Process
1. Dry blend the guar, SSL, and whey solids
2. Add water to a blender
3. Add preblend to blender and mix under high shear
4. While blending, add oil and continue to blend for 3 minutes
   Glaze Application and Baking Process
1. frozen product is dipped in glaze at 40 F; application is approximately 3-5 g per 42 g piece
2. Glaze is allowed to temper at −10 F to ensure fit is frozen when placed in oven
   Baking
   Process
1. A rack oven (Baxter) is preheated to 325 F
2. Frozen glazed product is placed on parchment lined baking sheets
3. Product is placed in oven and treated with 15 seconds of steam
4. Product is baked for a minimum of 30 minutes and pulled when desired color is obtained.
   Arise 8000 Wheat protein isolate (concentrated protein ingredient), and Midsol 35 Hydroxypropylated oxidized wheat starch (low, high-temperature viscosity starch) are available from Midwest Grain Products Atchinson, Kans.

1. A dough composition comprising water; yeast; flour; concentrated protein ingredient; and starch having a low, high-temperature viscosity.

2. The dough composition of claim 1 wherein the starch exhibits a peak high-temperature viscosity of less than 5000 centipoise when tested according to AACC Method 76-21.

3. The dough composition of claim 1 wherein a total amount of starch ingredient and flour, when combined and tested according to AACC Method 76-21, exhibits a peak high-temperature viscosity of no greater than 4900 centipoise.

4. The dough composition of claim 1 wherein the dough comprises from 5 to 30 weight percent starch having a low, high-temperature viscosity.

5. The dough composition of claim 1 wherein the starch is selected from the group consisting of modified corn starch, modified wheat starch, and combinations thereof.

6. The dough composition of claim 1 wherein the starch comprises amylopectin as a component of a waxy wheat flour.

7. The dough composition of claim 1 wherein the starch comprises amylopectin contained in a starch ingredient.

8. The dough composition of claim 1 wherein the starch is contained in a starch ingredient comprising a starch selected from the group consisting of a modified corn starch, modified wheat starch, amylopectin, and combinations thereof.

9. The dough composition of claim 1 comprising from 3 to 20 weight percent concentrated protein ingredient.

10. The dough composition of claim 9 wherein the concentrated protein ingredient is selected from the group consisting of vital wheat gluten, wheat protein isolate, and mixtures thereof.

11. The dough composition of claim 1 wherein the dough composition comprises
from 3 to 20 weight percent concentrated protein ingredient selected from the group consisting of vital wheat gluten, wheat protein isolate, and mixtures thereof;
from 5 to 30 weight percent starch having a low, high-temperature viscosity.

12. The dough composition of claim 11 wherein the starch is amylopectin.

13. The dough composition of claim 1 comprising
a dough preferment composition comprising water, yeast, and yeast food, and
additional dough ingredients comprising flour,
wherein the dough composition comprises
concentrated protein ingredient, and
starch having a low, high-temperature viscosity.

14. A method of preparing a dough composition, the method comprising combining ingredients comprising water, yeast, yeast nutrient, and concentrated protein ingredient, wherein the dough composition comprises starch having a low high-temperature viscosity.

15. The method of claim 14 wherein the starch having a low high-temperature viscosity is contained in a dough ingredient selected from the group consisting of: a modified corn starch ingredient, a modified wheat starch ingredient, a waxy wheat flour, an amylopectin ingredient, and combinations thereof.

16. The method of claim 14 wherein the ingredients are combined using a straight-dough method.

17. The method of claim 14 comprising
preparing a preferment dough composition from ingredients comprising water, yeast, and yeast nutrient,
resting the preferment dough composition, and
combining the rested preferment dough composition with additional dough ingredients comprising flour and water.

18. The method of claim 17 wherein
the preferment dough ingredients include a concentrated protein ingredient,
the dough composition contains no chemical leavening agent, and
the starch having a low high-temperature viscosity is contained in a dough ingredient selected from the group consisting of a waxy wheat flour, amylopectin, a modified wheat starch ingredient, a modified corn starch ingredient, and combinations thereof.

19. The method of claim 17 wherein the entire amount of yeast of the dough composition is included in the preferment ingredients.

20. The method of claim 17 comprising resting the preferment dough composition for a time in the range from 15 to 120 minutes, before combining the preferment dough composition with the additional dough ingredients.

21. The method of claim 14 wherein the dough composition is an unproofed dough composition having a raw specific volume in the range from 0.9 to 1.1 cubic centimeters per gram, the method comprising baking the unproofed dough composition to a baked specific volume in the range of 3.5 to 10 cubic centimeters per gram.

22. The method of claim 21 comprising
freezing the unproofed dough composition, and
baking the frozen dough composition without proofing, to a baked specific volume in the range of 3.5 to 10 cubic centimeters per gram.

23. The method of claim 21 comprising
freezing the unproofed dough composition, and
baking the frozen dough composition without proofing or thawing, to a baked specific volume in the range of 3.5 to 7 cubic centimeters per gram.

24. The method of claim 14 comprising
preparing a preferment dough composition from preferment ingredients comprising, based on total weight of the preferment:
from 6 to 14 weight percent concentrated protein ingredient,
amylopectin as a component of an ingredient selected from the group consisting of a waxy wheat flour, a starch ingredient, and combinations thereof, and
combining the preferment dough composition with additional dough ingredients comprising flour and water.
